(19) United States
(12) Patent Application Publication
(10) Pub. No.: US 2007/0205896 A1
(43) Pub. Date: Sep. 6, 2007

(54) System and Method for Determining Location, Directionality, and Velocity of RFID Tags

(75) Inventors: Michael H. Beber, Plano, TX (US); Michael A. Klinke, Dallas, TX (US); Rajinder Bridgelall, Plano, TX (US)

Correspondence Address: BAKER BOTTS L.L.P., 2001 ROSS AVENUE, SUITE 600, DALLAS, TX, 75201-2980, US

(73) Assignee: Axcess International Inc., Carrollton, TX (US)

(21) Appl. No.: 11/681,560

(22) Filed: Mar. 2, 2007

Related U.S. Application Data
(60) Provisional application No. 60/764,285, filed on Mar. 2, 2006.

(51) Int. Cl. G08B 13/14

(52) U.S. Cl. 340/572.1

(57) ABSTRACT

In certain embodiments, a method for tracking tags includes transmitting wake-up signals from a number of activation antennas located throughout an environment. Each wake-up signal includes an antenna ID of the antenna that transmitted the wake-up signal. A plurality of identification signals are received from a tag, each identification signal generated in response to receipt by the tag of a wake-up signal from a corresponding antenna and including a tag ID of the tag and the antenna ID included in the wake-up signal of the antenna that transmitted the wake-up signal. A directionality of the tag is determined based on the sequence in which the plurality of identification signals are received from the tag.

### RELATED APPLICATION

This application claims the benefit under 35 U.S.C. § 119(e) of U.S. Provisional Application No. 60/764,285, entitled, “System and Method for Determining Location and Directionality of RFID Tags,” filed on Mar. 2, 2006.

### TECHNICAL FIELD

This invention relates in general to radio frequency identification (RFID) systems, and more particularly to system and method for determining location, directionality, and velocity of RFID tags.

### BACKGROUND

The management and tracking of personnel, assets, and other objects is required in a wide variety of environments and is often cumbersome, labor intensive, and expensive. Radio receivers and transmitters have been used for many years to identify personnel and objects in such environments. For example, many systems are known for attaching radio tags to items, such as personnel, assets, and automobiles. When automobiles equipped with radio tags enter a certain area, such as a toll booth area, the automobiles are automatically identified. The appropriate tolls are deducted from corresponding accounts, thereby eliminating the need for drivers to stop and make payments at toll booths. When radio tags are placed on personnel, they can be automatically identified and checked for authorized entry to a facility in a security application called access control. Assets which are tagged can be identified and tracked as they move throughout a facility for the purposes of automatically locating them. They can also be automatically counted therefore providing inventory control. They can also be protected as when an asset approaches an exit doorway the system can automatically determine if the asset is authorized to be removed from the facility. Tagged vehicles, assets, and personnel can be linked logically in the system to enable greater visibility and control.

Radio frequency identification (RFID) systems generally use a fixed position transmitter capable of reading remote, portable tags attached to personnel, assets, or other objects. Because of power consumption concerns and the life span of the tag, the radio tag often operates only after receiving a wake-up signal, often called semi-active operation. The wake-up signal is generated by a powered device called an activator which transmits the desired signal through a specially designed antenna based upon the physical properties of the area. Activation causes the tag to leave a low power state and enter an active state. The activation transmitter produces the wake-up signal, and an antenna transmits the wake-up signal to a particular area. Tags receiving the wake-up signal then wake-up and transmit a message to an associated receiver. This message may include an ID associated with the tag so that the location of the tag can be identified and tracked.

One issue that is presented in managing assets and personnel using RFID tags is the need to have greater accuracy in determining where a tag is located within the coverage of a receiver's RF footprint (the area within which the receiver can receive signals transmitted from tags). Active tags which are always transmitting enter the receiver's footprint and are counted as “in the general area” of the receiver (which is not necessarily helpful if the receiver's footprint is very large). Granularity within an individual receiver's coverage area may be provided when using semi-active tags by assigning a unique ID to each activator. This unique ID is embedded within the activation signal used by the activator to wake-up tags. Upon receiving such an activation signal, the tag wakes-up, reads the activator ID and transmits the activator ID along with its unique tag ID to the receiver. Therefore, multiple doorways or control points (each with an associated activator) can exist within a given receiver footprint and the receiver can determine where a tag is within the footprint based on the activator ID sent by the tag. Therefore, this provides greater granularity and accuracy regarding a tag's location.

Another issue that is presented in managing assets and personnel using RFID tags is the need to accurately determine the directionality of a tag (the direction in which the tag is moving) and determine whether a tag is inside or outside a door or other control point. The determination may be important for accurate inventory counting. Also, many potential uses of RFID tagging require the ability to determine directionality, such as in security applications or in otherwise determining if a person, asset, or vehicle is going in or out of an area.

### SUMMARY

According to the present invention, disadvantages and problems associated with previous RFID tag systems and methods may be reduced or eliminated.

In certain embodiments, a system and method is provided for detecting the presence, location, directionality of movement, and velocity of an RFID tag placed on a person, asset, or vehicle. A method for tracking tags may include generating first and second wake-up signals to be transmitted by first and second antennas, respectively. The first wake-up signal includes an antenna ID of the first antenna, and the second wake-up signal includes an antenna ID of the second antenna. A first identification signal is received from a tag in response to the receipt by the tag of the first wake-up signal. The first identification signal includes a tag ID of the tag and the antenna ID included in the first wake-up signal. A second identification signal is received from the tag in response to the receipt by the tag of the second wake-up signal. The second identification signal includes the tag ID of the tag and the antenna ID included in the second wake-up signal. Timing information for the first identification signal and the second identification signal is accessed. Location information associated with the first and second antennas is accessed. A velocity of the tag is determined based at least on the timing information for the first identification signal and the second identification signal and the location information associated with the first and second antennas.

In certain embodiments, a method for tracking tags includes transmitting wake-up signals from a number of activation antennas located throughout an environment. Each wake-up signal includes an antenna ID of the antenna that transmitted the wake-up signal. A plurality of identification signals are received from a tag, each identification signal generated in response to receipt by the tag of a wake-up signal from a corresponding antenna and including a tag ID of the tag and the antenna ID included in the wake-up signal of the antenna that transmitted the wake-up signal. A directionality of the tag is determined based on the sequence in which the plurality of identification signals are received from the tag.

In certain embodiments, a tag tracking system includes a first activation antenna and a second activation antenna. The system also includes one or more antenna control modules that are operable to generate a first wake-up signal to be transmitted by the first antenna and a second wake-up signal to be transmitted by the second antenna. The first wake-up signal includes an antenna ID of the first antenna and the second wake-up signal includes an antenna ID of the second antenna. Furthermore, the system includes a receiver that is operable to receive at least a first identification signal and a second identification signal from a tag. The first identification signal is received from the tag in response to the receipt by the tag of the first wake-up signal. The first identification signal includes a tag ID of the tag and the antenna ID included in the first wake-up signal. The second identification signal is received from the tag in response to the receipt by the tag of the second wake-up signal. The second identification signal includes a tag ID of the tag and the antenna ID included in the second wake-up signal. The receiver is further operable to determine the directionality of the tag based on the sequence in which the first and second identification signals are received from the tag.

Particular embodiments of the present invention may provide one or more technical advantages. In certain embodiments, the use of two ID-enabled activation antennas creates two different fields for tag activation. In particular embodiments, a tag passing through the fields at a gate, door or other control point will transmit (at least) two times, with each of the two transmissions having a different associated antenna ID. The first transmission includes the unique ID of the first antenna whose field it passes through and the second transmission includes the unique ID of the second antenna whose field it passes through. When the tag reads are compared, the directionality of the tag can be determined (for example, whether it is going into or out of a facility, into or out of a gated area, or into or out of an area in a building). Moreover, in certain embodiments, timing and location information may be used to determine a velocity of the tag.

Furthermore, particular embodiments of the present invention eliminate the cost of having two separate activators (one for each antenna) by using a switch that alternates between the two antennas and thus causes the system to deliver wake-up signals with alternating antenna IDs. The activator communicates a wake-up signal with one ID to one antenna, and then switches to the second antenna to a wake-up signal with a second ID to the second antenna, and repeats.

Particular embodiments of the present invention provide the advantage of being able to determine in certain security applications if a tagged person, asset, or vehicle is inside or outside a secured area. Reliably determining a tag's position enables security system response to concerns of missing assets or unwanted intrusion.

Furthermore, certain embodiments enable a low cost, accurate method of locating tags attached to persons, assets, and vehicles in physical or logical zones defined by the boundaries of multiple dual antenna installations at gateways, doors, or hallways. This approach allows for flexibility in the design of control zones where the number of zones in a given area can relate to how specific a location determination for a tag must be. For some applications such as the dynamic location of medical assets in hospitals, the greater the number of zones, the smaller the zone area and the more precisely the location of tags can be determined.

Moreover, particular embodiments of the present invention may also include the use self-tuning antennas with the activators. Such self-tuning antennas automatically tune the frequency and/or power at which the antenna transmits to adjust for changes in environmental conditions which may affect the antennas.

In certain embodiments, the present invention may consider a number of identification signals received from a tag in response to receipt by the tag of a number of wake-up signals from a number of activation antennas. A receiver or other component of the system may use this information to determine the location, directionality, and velocity of the tag. Using information in identification signals for a number of antennas may provide a more accurate or more useful measure of the movement of the tag throughout an environment.

Certain embodiments of the present invention may provide some, all, or none of the above advantages. Certain embodiments may provide one or more other technical advantages, one or more of which may be readily apparent to those skilled in the art from the figures, descriptions, and claims included herein.

### BRIEF DESCRIPTION OF THE DRAWINGS

For a more complete understanding of the present invention and its advantages, reference is made to the following descriptions, taken in conjunction with the accompanying drawings, in which:

FIG. 1 illustrates an example tag tracking system for determining the location, directionality, and velocity of RFID tags;

FIG. 2 illustrates further details of an example dual activator control module;

FIG. 3 illustrates further details of an example switch;

FIG. 4 illustrates an example method for tracking tags according to certain embodiments of the present invention;

FIG. 5 illustrates another example embodiment of a tag tracking system that includes a number of activation points 202 located throughout an environment; and

FIG. 6 illustrates an example method for tracking tags in a tag tracking system that comprises a plurality of activation antennas.

### DESCRIPTION OF EXAMPLE EMBODIMENTS

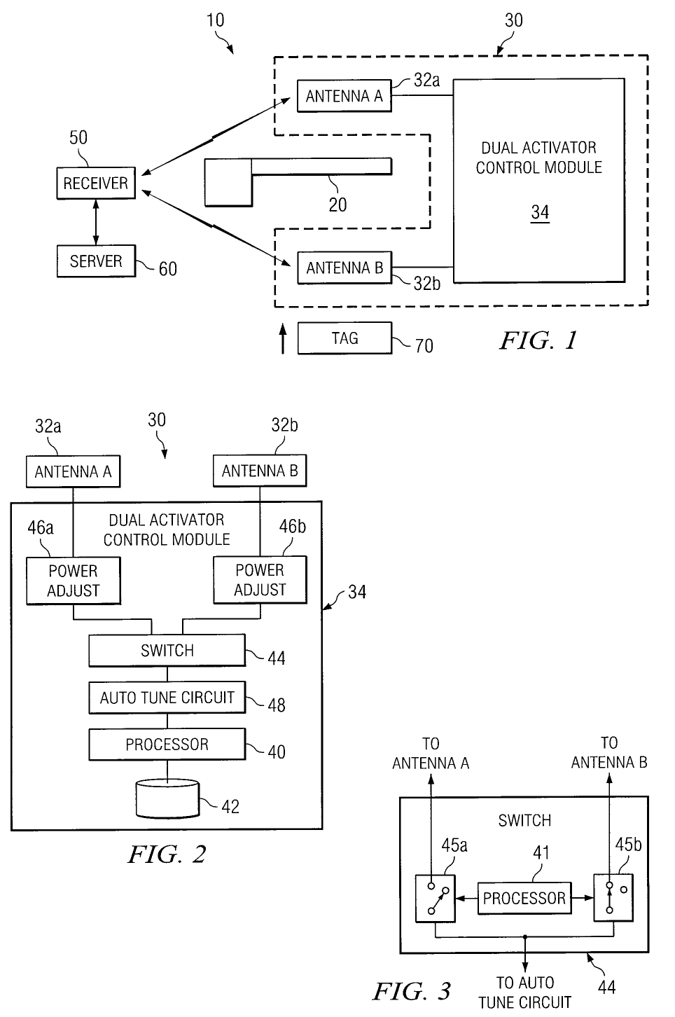

FIG. 1 illustrates an example tag tracking system 10 for determining the location, directionality, and velocity of RFID tags. System 10 includes a control point 20, a dual antenna activation system 30, a receiver 50, and a server 60. System 10 is used to track one or more RFID tags 70 moving in the vicinity of system 10. Although system 10 is illustrated as only having a single control point 20 and an associated activation system 30, it should be understood that system may include a number of control points 20, each having an associated activation system 30. A single receiver 50 may be used to receive information from a plurality of such activation systems 30. Furthermore, a single server 60 may be associated with a plurality of receivers 50. In particular embodiments, the functions of receiver 50 and server 60 may be combined in a single unit.

As discussed above, one problem associated with automatically activating semi-active RFID tags is the need to accurately determine directionality and whether a tag is inside or outside a door or other control point. Using a single antenna to activate a tag provides a snapshot of the location of the tag at the activation point but a problem exists when trying to determine which side of the door (or other control point) the tag is on, as the radio frequency (RF) fields for wake-up and receiving typically will cover both sides of the door or other control point (thus one is not able to determine in which direction a tag is passing through a control point).

However, by using a control point that has two different associated antennas, each with a different unique ID, an accurate location and direction of a tag can be determined. Each activator antenna includes a unique antenna ID in the wake-up signal transmitted by the antenna used to activate a tag. Upon receipt of this wake-up signal, a tag will transmit both its unique tag ID and the antenna ID of the activation antenna. As described in further detail below, the use of two ID-enabled activator-driven antenna fields can be used to determine the direction of movement of a tag (and thus the associated tagged item) by determining the sequence in which the two antenna fields activated the tag.

RFID tags 70 are portable tags that can be affixed to and identify mobile objects such as a person, a vehicle, or a piece of inventory. RFID tags 70 may send a wireless signal (using radio frequency or other suitable wireless transmission technologies) that uniquely identifies a person or object (or a type or class of people or objects). In particular embodiments, RFID tags 70 comprise semi-active radio tags that contains a local, self-contained power supply for providing power to the internal components of the tag. However, any suitable type of tag may be used in any suitable combination, such as active tags or passive tags. Each tag may have an associated unique ID.

Control points 20 may be any suitable location at which it may be desired to control access to an area and/or to determine the proximity, direction of travel, and velocity of a tag 70. For example, a control point 20 may be associated with a gate, a door, or a portal/doorway. Control point 20 need not be associated with a device that actually impedes movement through control point 20 (such as a gate or a door), but may simply be a monitoring point of some kind.

An activation system 30 is positioned in proximity to the control point 20 such that a first antenna 32a (“ANT A”) is located on one side of the control point 20 and a second antenna 32b (“ANT B”) is located on the other side of the control point 20. Each antenna 32 has an associated unique antenna ID. In the illustrated embodiment, antennas 32 are coupled to a dual activator control module 34. Antennas 32 receive signals generated by control module 34 and transmit the signals in a certain geographic space to create an RF field. The size of the RF field is typically defined by the tuning and power of the antennas 32. Each antenna 32 may comprise any suitable antenna, such as a small wall-mount proximity head antenna that generates an RF field in a room or a road loop that generates an RF field on a road or other vehicle surface.

As will be described in further detail below, control module 34 controls the antennas 32 by causing them to alternately send out wake-up signals. Although a single control module 34 is illustrated (which may reduce the cost of the system), each antenna 32 may be alternatively controlled by a separate control module. The wake-up signal sent by antennas 32 may cause any tag 70 within the range of the wake-up signal to leave a low power state and enter an active state, or may otherwise trigger activity by tag 70. The wake-up signal may be sent using any suitable signal, such as a low frequency (LF) or very low frequency (VLF) signal (for example, in a particular embodiment, the wake-up signal is a 126 kHz signal). The wake-up signal includes the antenna ID of the antenna 32 sending the signal. In certain embodiments, the wake-up signal may include timing information (e.g., a time stamp). Tags 70 receiving the wake-up signal may wake-up and transmit an identification signal to receiver 50 (as an example, in a particular embodiment, this identification signal may be transmitted at 315 MHz). This identification signal may include the unique ID of the tag 70 and the unique antenna ID of the antenna 32 from which the wake-up signal was received. Other information may also be included as desired. For example, as will be described in more detail below, the identification signal may include timing information.

As described above, receiver 50 may have an RF footprint that includes a number of control points 20 and associated activation systems 30. Therefore, receiver 50 may receive identification signals from a number of tags 70 that have been activated by different activation systems 30 (each being associated with a particular control point 20). Receiver 50 processes the identification signals received from a tag 70 and extracts the information contained in the identification signals. Using this information, as described below, receiver 50 may determine the directionality and/or the velocity of the tag 70. Receiver 50 may also use the received information to perform other functions. For example, receiver 50 may determine if an employee wearing a particular tag 70 has authority to pass through a control point 20 (for example, by accessing a database of access rights stored at the receiver 50). Furthermore, receiver 50 may be communicatively coupled to the control point 20. If a user has authority to pass through a control point 20, receiver 50 may instruct control point 20 to allow tag 70 to pass (for example, by sending a signal to unlock a door or open a gate).

Alternatively, one or more of these functions (determining directionality, determining velocity, determining access rights, controlling a control point 20, etc.) may be performed by server 60. In this case, receiver 50 may transmit the information received from the tag (such as the IDs of the tag and the activating antenna 32) and the server 60 may perform one or more of these functions. The functions of receiving the signal from a tag 70, processing the signal, and performing one or more calculations or functions based on the information in the signal may be distributed between receiver 50 and server 60 in any suitable manner. In particular embodiments, receiver 50 and server 60 may be combined. Furthermore, in embodiments that include multiple receivers 50, server 60 may serve as a central processing point to which the multiple receivers 50 send received information.

Receiver 50 and server 60 may each include one or more processing modules and one or more memory modules. The one or more processing modules (e.g., a microprocessor) may include one or more processing units, which may include one or more microprocessors, controllers, or any other suitable computing devices or resources. Each memory module may take the form of volatile or non-volatile memory including, without limitation, magnetic media, optical media, random access memory (RAM), read-only memory (ROM), removable media, or any other suitable memory component. In certain embodiments, a memory module comprises one or more databases, such as one or more structure query language (SQL) databases.

Tag 70 may include one or more processing modules and one or more memory modules. The one or more processing modules (e.g., a microprocessor) may include one or more processing units, which may include one or more microprocessors, controllers, or any other suitable computing devices or resources. Each memory module may take the form of volatile or non-volatile memory including, without limitation, magnetic media, optical media, RAM, ROM, removable media, or any other suitable memory component.

Before the operation of the system 10 is described in detail, further details of the components of dual antenna activation system 30 are described in conjunction with FIGS. 2 and 3.

FIG. 2 illustrates further details of an example dual activator control module 34. The example control module 34 includes a processor 40 and an associated computer-readable medium 42 (such as memory or a storage device). Processor 40 is operable to generate wake-up signals for transmission by antennas 32. As described briefly above, the wake-up signal sent by an antenna 32 includes its associated antenna ID. Thus, processor 40 includes one of the antenna IDs in the wake-up signal (depending upon which antenna 32 is to transmit the signal). In particular embodiments, the antenna IDs of antennas 32a and 32b may be stored in computer-readable medium 42. Processor 40 generates alternating wake-up signals for the antennas 32 (one for antenna 32a to transmit, one for antenna 32b to transmit, etc.). As described below, the frequency at which the wake-up signals are alternately generated depends upon the particular application.

FIG. 3 illustrates further details of an example switch 44. Each generated signal is communicated from processor 40 to an associated switch 44. At switch 44, the generated signals received from processor 40 are split and sent to two different switches 45a and 45b (as shown in FIG. 3). In particular embodiments, as an example only, switches 46 may be high voltage field-effect transistors. Using a processor (which may be processor 40 or a separate processor 41), switches 45 are alternately turned on and off (made to open and close) such that when switch 45a is closed, switch 45b is open (and vice versa). Alternatively, a single switch could be used to either send a received signal to one or the other of the antennas 32 (with one position of the switch sending the signal to antenna 32a and the other position of the switch sending the signal to antenna 32b). In this way, a signal received from processor 40 is either sent through switch 45a and ultimately to antenna 32a or is sent through switch 45b and ultimately to antenna 32b. Processor (40 or 41) coordinates the opening and closing of switches 45 with the alternation of wake-up signals generated by processor 40 such that wake-up signals including the antenna ID of antenna 32a are sent to antenna 32a and wake-up signals including the antenna ID of antenna 32b are sent to antenna 32b. Therefore, if separate processors 40 and 41 are used, these processors may be communicatively linked or otherwise synchronized.

The wake-up signals are alternately sent from antennas 32 such that any tag 70 moving through an associated control point 20 will receive at least one wake-up signal from each of the antennas 32 (although a tag 70 may receive multiple wake-up signals from each antenna 32). The frequency at which the wake-up signal is switched between antennas 32 thus depends on the application. For example, if tags 70 are associated with fast-moving vehicles, the wake-up signals need to be switched fairly quickly between antennas 32 to ensure that the tag 70 is activated by both antennas 32 (so directionality may be determined). On the other hand, if tags 70 are associated with pedestrians, the wake-up signals may be switched between the antennas 32 with less frequency. In an example embodiment, the wake-up signal sent from the processor 40 is switched from one antenna to the other approximately every second (and thus the processor 40 generates a different wake-up signal every second—alternating between a wake-up signal with the antenna ID of antenna 32a and the antenna ID of 32b).

Returning to FIG. 2, before being communicated through a switch 45 to an associated antenna 32 for transmission, a signal may pass through an associated power adjustment module 46a or 46b included in control module 45. Power adjustment module 46 may be used to control the size of the transmission field of the antennas 32. For example, as is described below, it may be desirable that the transmission fields (footprints) of antennas 32a and 32b do not overlap so that a tag 70 does not receive a wake-up signal from both antennas 32 at the same time. Such overlapping may confuse the tags in particular circumstances and cause a failure of or error in the transmission of the identification signal. The field size may be adjusted accordingly upon installation and/or during operation using power adjustment modules 46.

Moreover, control module 34 may also include, in particular embodiments, an auto-tune circuit 48. Such an auto-tune circuit and its associated functionality is described in detail in U.S. patent application Ser. No. 09/604,862, entitled “System and Method for Tuning a Radio Frequency Antenna,” which is incorporated herein by reference. Such an auto-tune circuit 48 may be useful since RF transmitters are often susceptible to changes in environmental conditions. For example, an antenna in a room may be affected by metallic door frames and concrete floors. These environmental conditions may detune the transmitter or change the frequency and power of the wake-up signals transmitted by the activator antenna. The altered frequency and power level may prevent tags 70 from entering an active state. To address this problem, conventional activators typically include a manual antenna tuning unit to tune the associated antenna during initial installation. However, one or more drawbacks may be associated with such manual tuning.

As described in detail in U.S. patent application Ser. No. 09/604,862, an auto-tune circuit is operable to automatically tune a radio frequency antenna to the installation environment after detecting a triggering event. Rather than having a technician manually try to determine the correct adjustments, the auto-tune circuit 48 quickly identifies optimal settings used to transmit the wake-up signal in a given area and tunes antennas 32 accordingly. This may help to reduce the amount of time needed for a technician to install each antenna 32 and improves the accuracy of tuning the antennas 32. Auto-tune circuit 48 may dynamically retune antenna 32 on a periodic basis (for example, every day) or it may retune the antennas whenever the power level of the wake-up signals sent from antennas 32 falls below a certain threshold level or changes by a threshold amount. This allows activation system 30 to retune itself in real-time and adjust to changing environmental conditions.

It should be noted that although a dual antenna control module 34 is illustrated, each antenna 32 may be separately controlled. For example, each antenna 32 may have an associated processor 40 (and optionally a separate power adjustment module 46 and auto-tune circuit 48) that generates its associated wake-up signal. Therefore, in such embodiments, no switch 44 is needed. Each antenna 32 may constantly transmit its own wake-up signal (generated by the associated processor) without the need to switch between antennas 32. As mentioned above, such a system may be more expensive than a shared dual antenna control module (although it potentially may also be more reliable).

In operation of an example embodiment of tag tracking system 10, system 10 may be used to determine the location, directionality, and velocity of a tag 70 as follows. As a tag 70 approaches a control point 20, the tag 70 moves into the field of one of the antennas 32 associated with the control point 20 (the antenna 32 on the side of the control point 20 that is closest to the tag 70). In the example illustrated in FIG. 1, tag 70 approaches control point 20 on the side associated with antenna 32b. Continuing with this example, as tag 70 moves into the RF field of antenna 32b, tag 70 receives the wake-up signal being transmitted by antenna 32b. By controlling the size of the antenna fields, tag 70 will not receive a wake-up signal from antenna 32a at this point (in fact, the fields of the antennas 32 may not overlap at all in particular embodiments). In response to receiving the wake-up signal from antenna 32b (which includes the antenna ID of antenna 32b), tag 70 transmits an identification signal that includes the received antenna ID and the tag ID of tag 70. This identification signal is received by receiver 50. Tag 70 may transmit this identification signal multiple times as it moves through the field of antenna 32b.

As the tag moves though control point 20 (receiver 50 and/or server 60 may open the control point 20, if applicable, based on a confirmation that tag 70 should have access through the control point 20), tag 70 will move out of the RF field of antenna 32b and into the RF field of antenna 32a. There may be a gap between these fields such that tag 70 stops transmitting when moving between the two antennas 32. Upon leaving the field of antenna 32b and entering the field of antenna 32a, tag 70 will receive the wake-up signal transmitted from antenna 32a (which includes the antenna ID of antenna 32a). Upon receiving this wake-up signal, tag 70 transmits an identification signal that includes the received antenna ID of antenna 32a and the tag ID of tag 70. This identification signal is again received by receiver 50. Receiver 50 and/or server 60 may store (at least temporarily) a record of the series of identification signals received from tag 70 and the information contained therein. Thus, receiver 50 and/or server 60 are able to determine that the identification signals sent from tag 70 first included the antenna ID of antenna 32a and then included the antenna ID of antenna 32b.

In certain embodiments, receiver 50 and/or server 60 may use at least a portion of the information received from tag 70 to determine the direction of movement (directionality) of tag 70. For example, in this instance, receiver 50 and/or server 60 determines that tag 70 moved through the control point 20 from the side associated with antenna 32b to the side associated with antenna 32a. Thus, using dual antenna activation system 30, the directionality of tags 70 moving through an associated control point 20 may be tracked.

In certain embodiments, receiver 50 and/or server 60 may use at least a portion of the information received from tag 70 to determine the velocity of tag 70 (and thereby the object associated with tag 70). The velocity of an object (e.g., a tag 70) is defined as the speed of the object in a particular direction. For purposes of this description, however, it will be assumed that velocity may be either speed or both speed and direction, according to particular needs. Speed is the scalar absolute value (e.g., the magnitude) of velocity.

In certain embodiments, the one or more processing units may access timing information for the first identification signal and the second identification signal. The timing information may include a first time stamp associated with the first identification signal (and/or the first wake-up signal) and a second time stamp associated with the second identification signal (and/or the second wake-up signal). The timing information have been generated or otherwise determined by tag 70. Additionally or alternatively, the one or more processing units may determine the timing information (e.g., in response to receiving the first and second identification signals). In certain embodiments, the timing information may comprise a time difference calculated from the first and second time stamps.

The one or more processing units may access location information associated with the first and second antennas. The location information may include any suitable information for determining an appropriate distance between the first and second antennas. In certain embodiments, location is stored in association with a memory module (e.g., a database) associated with the one or more processing units (e.g., receiver 50 and/or server 60).

The one or more processing units determine a velocity of the tag based at least on the timing information for the first identification signal and the second identification signal and the location information associated with the first and second antennas. In certain embodiments, the one or more processing units calculate the velocity of tag 70 according to the following formula:

v=s/t,

where s equals the displacement of the object and t equals a time interval. The displacement (s) of tag 70 may be determined according to the location information, and the time interval (t) may be determined according to the timing information.

For calculating the velocity of tag 70, receiver 50 and/or server 60 may use the accessed location information regarding the distance between activation antennas 32. For example, in this instance, receiver 50 and/or server 60 may store information regarding the distance between antennas 32a and 32b. Receiver and/or server 60 may determine the velocity of tag 70 by dividing the distance between antennas 32a and 32b by the time difference between the detections by tag 70 (which may be computed by tag 70 or at receiver 50 and/or server 60).

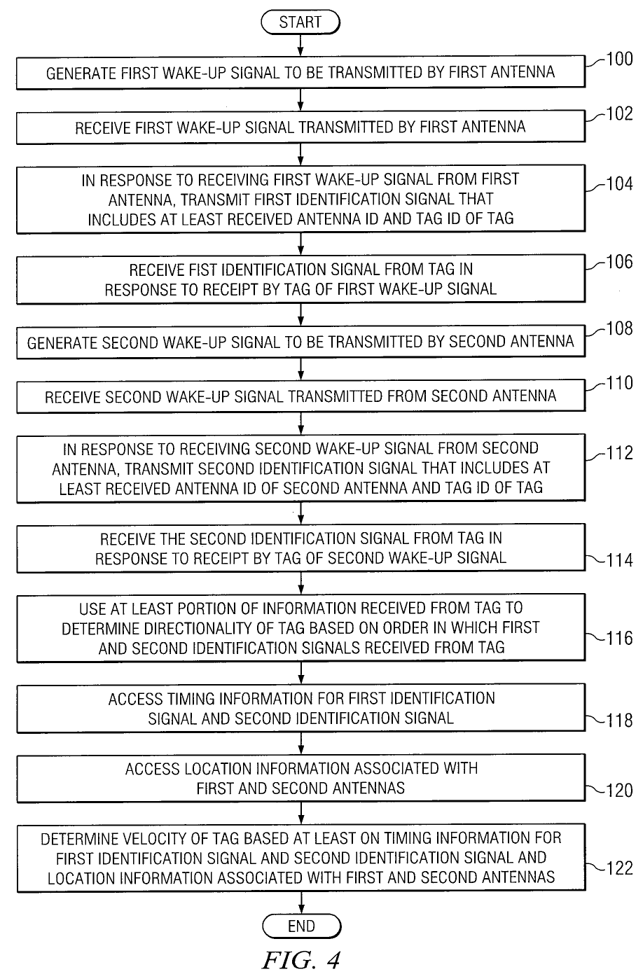

FIG. 4 illustrates an example method for tracking tags according to certain embodiments of the present invention. For example, the method may be used to determine the location, directionality, and velocity of tag 70. As tag 70 approaches a control point 20, tag 70 moves into the field of one of the antennas 32 associated with the control point 20 (the antenna 32 on the side of control point 20 that is closest to tag 70). For purposes of this example, tag 70 approaches control point 20 on the side associated with antenna 32b.

At step 100, antenna control module 30 may generate a first wake-up signal to be transmitted by a first antenna 32b. For example, dual activator control module 34 may generate the first wake-up signal to be transmitted by first antenna 32b. The first wake-up signal may be communicated at any suitable interval, according to particular needs. The first wake-up signal may include one or more of an antenna ID of antenna 32b, timing information indicating when the wake-up signal was generated, and any other suitable information, according to particular needs.

At step 102, as tag moves into the RF field of antenna 32b, tag 70 receives the wake-up signal being transmitted by antenna 32b. By controlling the size of the antenna fields, tag 70 may not receive a wake-up signal from antenna 32a at this point (in fact, the fields of the antennas 32 may not overlap at all in particular embodiments). At step 104, in response to receiving the wake-up signal from first antenna 32b, (which includes the antenna ID of antenna 32b), tag 70 transmits a first identification signal that includes the received antenna ID and the tag ID of tag 70, as well as any other suitable information. For example, the identification signal may include timing information, as described below. Tag 70 may transmit this identification signal multiple times as it moves through the field of antenna 32b.

At step 106, one or more processing modules (e.g., receiver 50 and/or server 60) may receive the first identification signal from tag 70, the first identification signal received from tag 70 in response to the receipt by tag 70 of the first wake-up signal and comprising the tag ID of tag 70 and the antenna ID included in the first wake-up signal (i.e., the antenna ID of first antenna 32b).

At step 108, antenna control module 30 may generate a second wake-up signal to be transmitted by a second antenna 32a. For example, dual activator control module 34 may generate the second wake-up signal to be transmitted by second antenna 32a. The second wake-up signal may be communicated at any suitable interval, according to particular needs. The second wake-up signal may include one or more of an antenna ID of antenna 32a, timing information indicating when the wake-up signal was generated, and any other suitable information, according to particular needs.

As tag 70 moves through control point 20 (receiver 50 and/or server 60 may open the control point 20, if applicable, based on a confirmation that tag 70 should have access through the control point 20), tag 70 will move out of the RF field of first antenna 32b and into the RF field of second antenna 32a. There may be a gap between these fields such that tag 70 stops transmitting when moving between the two antennas 32. At step 110, upon leaving the field of antenna 32b and entering the field of antenna 32a, tag 70 will receive the wake-up signal transmitted from second antenna 32a (which includes the antenna ID of antenna 32b).

At step 112, upon receiving this wake-up signal, tag 70 transmits a second identification signal that includes the received antenna ID of second antenna 32a and the tag ID of tag 70, as well as any other suitable information. For example, the identification signal may include timing information, as described below. Tag 70 may transmit this identification signal multiple times as it moves through the field of antenna 32b.

At step 114, one or more processing modules (e.g., receiver 50 and/or server 60) may receive the second identification signal from tag 70, the second identification signal received from tag 70 in response to the receipt by tag 70 of the second wake-up signal and comprising the tag ID of tag 70 and the antenna ID included in the second wake-up signal (i.e., the antenna ID of first antenna 32a).

Receiver 50 and/or server 60 may store (at least temporarily) a record of the series of identification signals received from tag 70 and the information contained therein. Thus, receiver 50 and/or server 60 are able to determine that the identification signals sent from tag 70 first included the antenna ID of antenna 32b and then included the antenna ID of antenna 32a.

At step 116, the one or more processing units (e.g., receiver 50 and/or server 60) may use at least a portion of the information received from tag 70 to determine the direction of movement (directionality) of tag 70, based on the order in which the first and second identification signals are received from tag 70. In the present example, the one or more processing units may determine that tag 70 moved through the control point 20 from the side associated with antenna 32b to the side associated with antenna 32a. Thus, using dual antenna activation system 30, the directionality of tags 70 moving through an associated control point 20 may be tracked.

At steps 118-122, the one or more processing units (e.g., receiver 50 and/or server 60) may use at least a portion of the information received from tag 70 to determine the velocity of tag 70 (and thereby the object associated with tag 70). At step 118, the one or more processing units may access timing information for the first identification signal and the second identification signal. The timing information may include a first time stamp associated with the first identification signal (and/or the first wake-up signal) and a second time stamp associated with the second identification signal (and/or the second wake-up signal). The timing information have been generated or otherwise determined by tag 70. Additionally or alternatively, the one or more processing units may determine the timing information (e.g., in response to receiving the first and second identification signals). In certain embodiments, the timing information may comprise a time difference calculated from the first and second time stamps.

At step 120, the one or more processing units may access location information associated with the first and second antennas. The location information may include any suitable information for determining an appropriate distance between the first and second antennas. In certain embodiments, location is stored in association with a memory module (e.g., a database) associated with the one or more processing units (e.g., receiver 50 and/or server 60).

At step 122, the one or more processing units determine a velocity of the tag based at least on the timing information for the first identification signal and the second identification signal and the location information associated with the first and second antennas. In certain embodiments, the one or more processing units calculate the velocity of tag 70 according to the following formula:

v=s/t,

where s equals the displacement of the object and t equals a time interval. The displacement (s) of tag 70 may be determined according to the location information, and the time interval (t) may be determined according to the timing information.

Although a particular method for tracking tag 70 has been described with reference to FIG. 4, the present invention contemplates any suitable methods in accordance with the present invention. Thus, certain of the steps described with reference to FIG. 4 may take place substantially simultaneously and/or in different orders than as shown and described. Moreover, components of system 10 may use methods with additional steps, fewer steps, and/or different steps, so long as the methods remain appropriate.

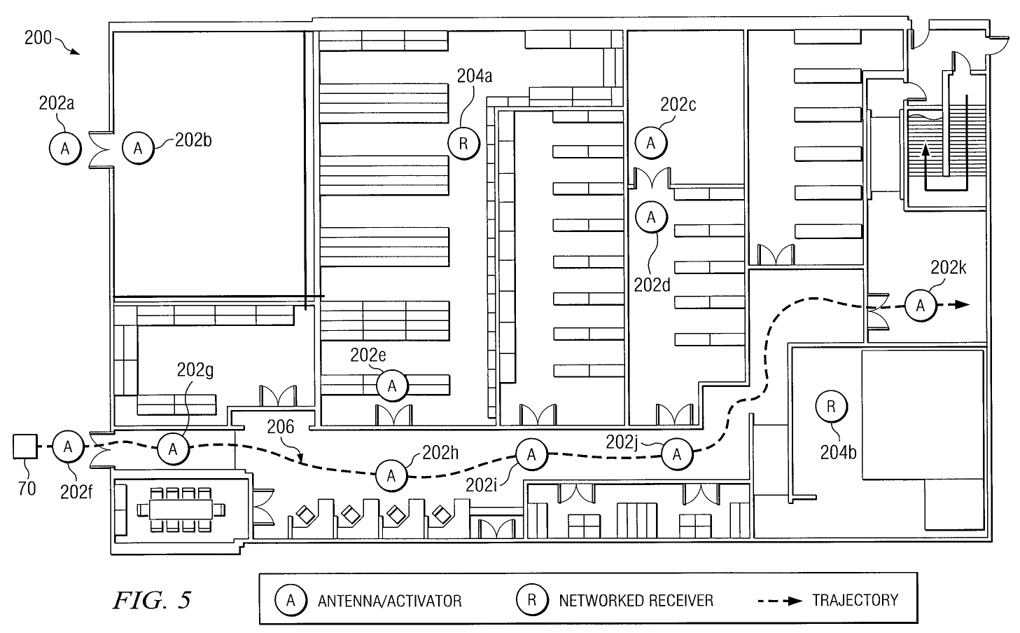

FIG. 5 illustrates another example embodiment of a tag tracking system 200 that includes a number of activation points 202 located throughout an environment. The environment may include any suitable type of environment, such as a warehouse, a library, an office building, a retail store, or any other suitable environment, indoors or outdoors.

System 200 includes a number of activation antennas 202 located throughout the environment. Each activation antenna 202 is operable to transmit a wake-up signal, the wake-up signal transmitted by an activation antenna 202 comprising an antenna ID of the antenna 202 that transmitted the wake-up signal. Each antenna 202 may comprise any suitable antenna, such as a small wall-mount proximity head antenna that generates an RF field in a room or a road loop that generates an RF field on a road or other vehicle surface. Antennas 202 may be associated with and may operate in conjunction with one or more control points 20 and one or more control modules 34, as described above. The wake-up signal transmitted by an antenna 202 may include one or more of an antenna ID of the antenna 202 that communicated the wake-up signal, timing information, and any other suitable information.

A tag 70, which may be affixed to an object (including a person) may move through the environment, along trajectory 206 for example. As tag 70 moves along trajectory 206, tag 70 may receive wake-up signals from the antennas 202 whose RF field tag 70 enters (e.g., antennas 202f-202k). In response to receiving a wake-up signal from an activation antenna 202, tag 70 may transmit an identification signal to one or more receivers 204 or other processing modules. Each identification signal transmitted by tag 70 may include one or more of the antenna ID of the antenna 202 whose wake-up signal caused tag 70 to send the identification signal, the unique tag ID of tag 70, timing information, and any other suitable information.

Receivers 204 may receive the plurality of identification signals transmitted by tag 70 as tag 70 moves along trajectory 206. As described below, receivers 204 may use the information in the identification signals received from tag 70 to determine the location, directionality, and/or velocity of tag 70. Receiver 204 may also use the received information to perform other functions. For example, receiver 204 may determine if an employee wearing a particular tag 70 has authority to pass through a control point associated with one or more of antennas 202 (e.g., by accessing a database of access rights stored at receiver 204). As described above, one or more of these functions may be determined by a server 60 or other processing module.

In operation of an example embodiment of tag tracking system 200, tag tracking system 200 may be used to determine the location, directionality, and velocity of a tag 70 as follows. As tag 70 moves along trajectory 206, beginning at antenna 202f and ending at antenna 202k, tag 70 moves into and out of the fields of antennas 202f-202k.

Activation antennas 202 located throughout the environment of system 10 may transmit wake-up signals. These activation signals may be transmitted substantially continuously or at any other suitable interval, according to particular needs. The wake-up signal transmitted by an activation antenna 202 comprises one or more of an antenna ID of the antenna 202 that transmitted the wake-up signal, a unique tag ID of tag 70, timing information, and any other suitable information.

As tag 70 moves along trajectory 206, tag 70 may receive the wake-up signals being communicated by the antennas 202 along trajectory 206. Thus, in the example illustrated in FIG. 5, tag 70 may receive the wake-up signals of antennas 202f-202k as tag 70 moves along trajectory 206.

As tag 70 receives the wake-up signals of the antennas 202 along trajectory 206 of tag 70, tag 70 may communicate identification signals to one or more of receivers 204. For example, as tag 70 receives the wake-up signals of antennas 202f-202k, tag 70 may transmit, for each received wake-up signal, an identification signal. Each identification signal may include one or more of the unique ID of tag 70, the antenna ID of the antenna 202 that communicate the wake-up signal (i.e., the wake-up signal that prompted tag 70 to communicate the identification signal, timing information, and any other suitable information.

Receiver 204 or another suitable component of system 10 (e.g., a server 60 or other suitable processing module) may receive the plurality of identification signals from a tag. each identification signal generated in response to receipt by tag 70 of a wake-up signal from a corresponding antenna 202 and comprising one or more of a tag ID of tag 70, the antenna ID included in the wake-up signal of the antenna 202 that transmitted the wake-up signal, timing information, and any other suitable information.

It will be understood that the identification signals may be received by receiver 204 at the time (or shortly thereafter) of communication of the identification signal by tag 70. For example, receiver 204 may not receive the identification signals for each of antennas 202f-202k in bulk, but may receive the identification signals as tag 70 moves along trajectory 206 and encounters the wake-up signals of each antenna 202. The present invention, however, does contemplate such bulk transmission of identification signals by tag 70, if appropriate for a particular application. Receiver 50 and/or server 60 may store (at least temporarily) a record of the series of identification signals received from tag 70 and the information contained therein.

Receiver 204 or another suitable component of system 10 (e.g., a server 60 or other suitable processing module) may determine a directionality of tag 70 based on the sequence in which the plurality of identification signals are received from tag 70. For example, receiver 204 may store or otherwise have access to location information that allows receiver 204 to determine the directionality of tag 70 based on the order in which the identification signals are received from tag 70. The location information may include, for example, a sequence of antennas 202 as they exist in the environment of system 10. As described above, each identification signal communicated by tag 70 may include an antenna ID of the antenna 202 whose wake-up signal caused tag 70 to communicate the identification signal. Receiver may access the stored location information and compare the sequence of antenna IDs for the received identification signals to the location information to determine the directionality of tag 70 in the environment of system 10.

Receiver 204 or another suitable component of system 10 (e.g., a server 60 or other suitable processing module) may determine the velocity of tag 70 (and thereby the object associated with tag 70) according to the information in two or more of the identification signals received from tag 70. In certain embodiments, to determine the velocity of tag 70, receiver 204 may access timing information associated with two or more of the identification signals, access location information associated with the antennas identified in the identification signals, and determine a velocity of the tag based on the timing information and the location information.

The timing information may include a time stamps for each of the identification signals received from tag 70. The timing information have been generated or otherwise determined by tag 70. Additionally or alternatively, the one or more processing units may determine the timing information (e.g., in response to receiving the identification signals). In certain embodiments, the timing information may comprise a time difference calculated from the first and second time stamps (e.g., either by tag 70 or receiver 204).

The location information may include any suitable information for determining an appropriate distance between antennas 202. In certain embodiments, location is stored in association with a memory module (e.g., a database) associated with the one or more processing units (e.g., receiver 50 and/or server 60).

In certain embodiments, the one or more processing units calculate the velocity of tag 70 according to the following formula:

v=s/t,

where s equals the displacement of the object and t equals a time interval. The displacement (s) of tag 70 may be determined according to the location information, and the time interval (t) may be determined according to the timing information. The computed velocity may be determined across any suitable portion of trajectory 206.

A variety of techniques may be used to facilitate the determination of the directionality and velocity of tag 70. In certain embodiments, tag 70 receives and logs each wake-up signal and associated timing information (e.g., a time stamp) received from antennas 202 as tag 70 moves along trajectory 206. Tag 70 may transmit this logged information at any time or upon demand to one or more of receivers 204. Receivers 204 or other processing modules may use this logged information to determine the directionality and velocity of tag 70.

In certain embodiments, tag 70 logs and transmits time differences between activation zones (e.g., the RF field of a particular antenna 202). Particular example techniques for determining the timing information are described below; however, the present invention contemplates determining the time information in any suitable manner.

In certain embodiments, tag 70 logs its internal digital counter differences between different wake-up signals (e.g., typically negative pulses derived from the wake-up signal) and broadcast the log of count differences to one or more receivers 204. Tag 70 may be configured to broadcast its entire log (e.g., across all antennas 202 encountered) or just a portion. Counters may be driven by clocks derived from on-board crystals or resonators, or may be derived from the RF cycles of the received wake-up signal. Receivers 204 may have prior knowledge of this clock frequency and may compute the actual time differences given the received count values.

In certain embodiments, tag 70 includes an on-board real-time-clock (RTC) unit and directly logs time differences between different wake-up signals. Tag 70 may broadcast the time differences or historical log (e.g., including antenna IDs and the unique tag ID of tag 70) to one or more receivers 204.

In certain embodiments, tag 70 decodes one or more time stamps and/or location coordinates transmitted by antennas 202 (e.g., as part of the wake-up signals). Tag 70 may compute the time differences locally at tag 70 and then broadcast the time differences or a subset of the log (including antenna IDs and the unique tag ID of tag 70) to one or more receivers 204. If antennas 202 also transmit location information (e.g., based on global position system coordinates) to tag 70, then tag 70 may log and transmit a requested subset of the location information.

In certain embodiments, tag 70 may include one or more sensors. For example, these sensors may include location-based sensors such as accelerometers, gyroscopes, electronic compasses, acoustic sensors, infrared sensors, chemical sensors, radiation sensors, or any other suitable types of sensors. Tag 70 may include any of these sensors, and any other types of sensors, in any suitable combination. The information determined by these sensors, which may include information detected, collected, generated, or otherwise determined by the sensors, may be referred to as sensor data.

Tag 70 may communicate all or a portion of the sensor data to one or more processing modules (e.g., receiver 50 and/or server 60). Tag 70 may perform this communication of sensor data in response to an activation trigger by an activation antenna 202, tag 70 may broadcast the sensor data on its own at a suitable interval, or tag 70 may communicate the sensor data in response to any other suitable event or at any other suitable interval. In certain embodiments, tag 70 communicates sensor data as part of the identification signal transmitted by tag 70 in response to a wake-up signal received by the tag from an activation antenna 202, although the present invention is not limited to such embodiments.

The one or more processing modules (e.g., receiver 50 and/or server 60) may receive the sensor data communicated by tag 70 and may use a portion or all of the sensor data to further assist in determining one or more of the location, directionality, and velocity of tag 70. For example, a heading (i.e., directional reading) determined by an electronic compass sensor of a tag 70 and received by the one or more processing units may enable the one or more processing units to more accurately determine the directionality of the tag 70 (either independently of or in combination with data included in one or more identification signals received from the tag 70). As another example, an acceleration reading determined by an accelerometer of a tag 70 and received by the one or more processing units may enable the one or more processing units to more accurately determine the velocity (which may include directionality) of the tag 70 (either independently of or in combination with data included in one or more identification signals received from the tag 70).

In certain embodiments, the one or more processing modules may use the sensor data to derive location information relative to the last activation point (e.g., a range of an activation antenna 202). For example, a tagged asset (or person) may exit a building through a doorway (which may include a activation antenna 202, such as activation antenna 202f in FIG. 5) and move around outdoors (where there may not be any activation antennas 202 installed). Outdoor locations may be populated with “landmark” emissions, such as chemicals, radiation, lighting, acoustic signatures, or other emissions. These landmarks may correspond to physical locations that are known to the one or more processing modules, so that a return of sensor data from tag 70 that identifies one of these landmark emissions may be used to determine one or more of the location, directionality, and velocity of tag 70. For example, a memory module accessible to the one or more processing modules may store location information associated with the one or more landmarks that are being “marked” with an emission. Additionally or alternatively, tag 70 may communicate sensor data that includes one or more of a heading (if tag 70 includes an electronic compass), a pitch and speed (if tag 70 includes an accelerometer), and timing data.

It should be noted that the techniques described with respect to the sensors may be used with any of the systems or methods described herein, or with any other suitable systems or methods, in accordance with the present description. Moreover, although use of the sensor data has been described primarily for purposes of determining one or more of the location, directionality, and velocity of tag 70, the sensor data may also inform the one or more processing units of one or more other conditions relating to the current environment of tag 70, and the one or more processing units may be programmed to incorporate this additional information in raising alerts or otherwise monitoring or reporting on the environment around a tag 70.

In certain embodiments, the ability to determine one or more of the location, directionality, and velocity of a tag 70 may facilitate the tracking of whether personnel and asset tags 70 are moving together or moving in different directions or to different locations. A personnel tag typically comprises a tag 70 that is associated with a person (e.g., an employee). An asset tag typically comprises a tag 70 that is associated with an object (e.g., an individual item or a pallet). It may be desirable to associate two or more tags 70 with each other. For example, it may be appropriate to associate an asset tag for a particular asset with a personnel tag for a particular employee. As a more particular example, an employee of a bank may be responsible for physically moving one or more containers of cash to the bank vault at a particular time of day. The employee's badge (which he or she may be required to wear at all times while at work) may include a tag 70 and each of the containers may include a tag 70. The ability to track one or more of the location, directionality, and velocity of the tags 70 may enable the one or more processing units to determine whether the tags are moving together, and if they are not, to raise an appropriate alert. As just one example, using the timing information and the antenna IDs included in the identification signals that may be communicated by tags 70, the one or more processing modules may be able to determine whether two tags 70 are in the same location at the same time and/or are moving together at substantially the same velocity.

Asset tags may also be associated with other asset tags. For example, it may be appropriate that two items be kept in proximity to one another. Personnel tags may also be associated with other personnel tags. For example, it may be appropriate to track whether a guest at a secure corporate facility is accompanied by an authorized employee, particularly if the guest is in a particular portion of the facility. In this scenario, both a tag 70 in the employee's badge and a tag 70 in the guest's badge may be associated with one another. This association may be stored in a memory module accessible to the one or more processing modules. If the two tags 70 are separated for a certain amount of time or at a certain location in the facility (or according to any other parameters), then the one or more processing modules may automatically raise an alert. Other example uses may include tracking associated combinations of personnel and assets at airports, casinos, pharmaceutical storage and/or distribution facilities, or any other suitable environment.

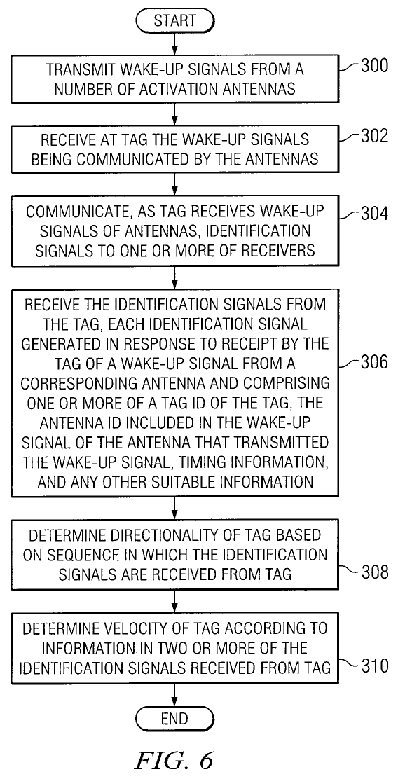

FIG. 6 illustrates an example method for tracking tags in a tag tracking system that comprises a plurality of activation antennas 202. For example, the method may be used to determine the location, directionality, and velocity of tag 70. As tag 70 moves along trajectory 206, beginning at antenna 202f and ending at antenna 202k, tag 70 moves into and out of the fields of antennas 202f-202k.

At step 300, activation antennas 202 located throughout the environment of system 10 may transmit wake-up signals. These activation signals may be transmitted substantially continuously or at any other suitable interval, according to particular needs. The wake-up signal transmitted by an activation antenna 202 comprises one or more of an antenna ID of the antenna 202 that transmitted the wake-up signal, a unique tag ID of tag 70, timing information, and any other suitable information.

At step 302, as tag 70 moves along trajectory 206, tag 70 may receive the wake-up signals being communicated by the antennas 202 along trajectory 206. Thus, in the example illustrated in FIG. 5, tag 70 may receive the wake-up signals of antennas 202f-202k as tag 70 moves along trajectory 206.

At step 304, as tag 70 receives the wake-up signals of the antennas 202 along trajectory 206 of tag 70, tag 70 may communicate identification signals to one or more of receivers 204. For example, as tag 70 receives the wake-up signals of antennas 202f-202k, tag 70 may transmit, for each received wake-up signal, an identification signal. Each identification signal may include one or more of the unique ID of tag 70, the antenna ID of the antenna 202 that communicate the wake-up signal (i.e., the wake-up signal that prompted tag 70 to communicate the identification signal, timing information, and any other suitable information.

At step 306, receiver 204 or another suitable component of system 10 (e.g., a server 60 or other suitable processing module) may receive the plurality of identification signals from a tag, each identification signal generated in response to receipt by tag 70 of a wake-up signal from a corresponding antenna 202 and comprising one or more of a tag ID of tag 70, the antenna ID included in the wake-up signal of the antenna 202 that transmitted the wake-up signal, timing information, and any other suitable information.

It will be understood that the identification signals may be received by receiver 204 at the time (or shortly thereafter) of communication of the identification signal by tag 70. For example, receiver 204 may not receive the identification signals for each of antennas 202f-202k in bulk, but may receive the identification signals as tag 70 moves along trajectory 206 and encounters the wake-up signals of each antenna 202. The present invention, however, does contemplate such bulk transmission of identification signals by tag 70, if appropriate for a particular application. Receiver 50 and/or server 60 may store (at least temporarily) a record of the series of identification signals received from tag 70 and the information contained therein.

At step 308, receiver 204 or another suitable component of system 10 (e.g., a server 60 or other suitable processing module) may determine a directionality of tag 70 based on the sequence in which the plurality of identification signals are received from tag 70. For example, receiver 204 may store or otherwise have access to location information that allows receiver 204 to determine the directionality of tag 70 based on the order in which the identification signals are received from tag 70. The location information may include, for example, a sequence of antennas 202 as they exist in the environment of system 10. As described above, each identification signal communicated by tag 70 may include an antenna ID of the antenna 202 whose wake-up signal caused tag 70 to communicate the identification signal. Receiver may access the stored location information and compare the sequence of antenna IDs for the received identification signals to the location information to determine the directionality of tag 70 in the environment of system 10.

At step 310, receiver 204 or another suitable component of system 10 (e.g., a server 60 or other suitable processing module) may determine the velocity of tag 70 (and thereby the object associated with tag 70) according to the information in two or more of the identification signals received from tag 70. In certain embodiments, to determine the velocity of tag 70, receiver 204 may access timing information associated with two or more of the identification signals, access location information associated with the antennas identified in the identification signals, and determine a velocity of the tag based on the timing information and the location information.

The timing information may include a time stamps for each of the identification signals received from tag 70. The timing information have been generated or otherwise determined by tag 70. Additionally or alternatively, the one or more processing units may determine the timing information (e.g., in response to receiving the identification signals). In certain embodiments, the timing information may comprise a time difference calculated from the first and second time stamps (e.g., either by tag 70 or receiver 204).

The location information may include any suitable information for determining an appropriate distance between antennas 202. In certain embodiments, location is stored in association with a memory module (e.g., a database) associated with the one or more processing units (e.g., receiver 50 and/or server 60).

In certain embodiments, the one or more processing units calculate the velocity of tag 70 according to the following formula:

v=s/t,

where s equals the displacement of the object and t equals a time interval. The displacement (s) of tag 70 may be determined according to the location information, and the time interval (t) may be determined according to the timing information. The computed velocity may be determined across any suitable portion of trajectory 206.

A variety of techniques may be used to facilitate the determination of the directionality and velocity of tag 70. In certain embodiments, tag 70 receives and logs each wake-up signal and associated timing information (e.g., a time stamp) received from antennas 202 as tag 70 moves along trajectory 206. Tag 70 may transmit this logged information at any time or upon demand to one or more of receivers 204. Receivers 204 or other processing modules may use this logged information to determine the directionality and velocity of tag 70.

In certain embodiments, tag 70 logs and transmits time differences between activation zones (e.g., the RF field of a particular antenna 202). Particular example techniques for determining the timing information are described below; however, the present invention contemplates determining the time information in any suitable manner.

In certain embodiments, tag 70 logs its internal digital counter differences between different wake-up signals (e.g., typically negative pulses derived from the wake-up signal) and broadcast the log of count differences to one or more receivers 204. Tag 70 may be configured to broadcast its entire log (e.g., across all antennas 202 encountered) or just a portion. Counters may be driven by clocks derived from on-board crystals or resonators, or may be derived from the RF cycles of the received wake-up signal. Receivers 204 may have prior knowledge of this clock frequency and may compute the actual time differences given the received count values.

In certain embodiments, tag 70 includes an on-board real-time-clock (RTC) unit and directly logs time differences between different wake-up signals. Tag 70 may broadcast the time differences or historical log (e.g., including antenna IDs and the unique tag ID of tag 70) to one or more receivers 204.

In certain embodiments, tag 70 decodes one or more time stamps and/or location coordinates transmitted by antennas 202 (e.g., as part of the wake-up signals). Tag 70 may compute the time differences locally at tag 70 and then broadcast the time differences or a subset of the log (including antenna IDs and the unique tag ID of tag 70) to one or more receivers 204. If antennas 202 also transmit location information (e.g., based on global position system coordinates) to tag 70, then tag 70 may log and transmit a requested subset of the location information.

Although a particular method for tracking tag 70 has been described with reference to FIG. 6, the present invention contemplates any suitable methods in accordance with the present invention. Thus, certain of the steps described with reference to FIG. 6 may take place substantially simultaneously and/or in different orders than as shown and described. Moreover, components of system 200 may use methods with additional steps, fewer steps, and/or different steps, so long as the methods remain appropriate.

Particular embodiments of the present invention may provide one or more technical advantages. In certain embodiments, the use of two ID-enabled activation antennas 32a and 32b creates two different fields for tag activation. In particular embodiments, a tag 70 passing through the fields at a gate, door or other control point 20 will transmit (at least) two times, with each of the two transmissions having a different associated antenna ID. The first transmission includes the unique ID of the first antenna 32b whose field it passes through and the second transmission includes the unique ID of the second antenna 32a whose field it passes through. When the tag reads are compared, the directionality of tag 70 can be determined (for example, whether it is going into or out of a facility, into or out of a gated area, or into or out of an area in a building). Moreover, in certain embodiments, timing and location information may be used to determine a velocity of tag 70.

Furthermore, particular embodiments of the present invention eliminate the cost of having two separate activators 34 (one for each antenna) by using a switch 44 that alternates between the two antennas 32a and 32b and thus causes the system to deliver wake-up signals with alternating antenna IDs. Activator 34 communicates a wake-up signal with one ID to one antenna 32a, and then switches to the second antenna 32b to communicate a wake-up signal with a second ID to the second antenna 32b, and repeats.

Particular embodiments of the present invention provide the advantage of being able to determine in certain security applications if a tagged person, asset, or vehicle is inside or outside a secured area. Reliably determining the position of a tag 70 enables security system response to concerns of missing assets or unwanted intrusion.

Furthermore, certain embodiments enable a low cost, accurate method of locating tags 70 attached to persons, assets, and vehicles in physical or logical zones defined by the boundaries of multiple dual antenna installations at gateways, doors, or hallways. This approach allows for flexibility in the design of control zones where the number of zones in a given area can relate to how specific a location determination for a tag 70 must be. For some applications such as the dynamic location of medical assets in hospitals, the greater the number of zones, the smaller the zone area and the more precisely the location of tags 70 can be determined.

Moreover, particular embodiments of the present invention may also include the use self-tuning antennas 32 with the activators 34. Such self-tuning antennas 32 automatically tune the frequency and/or power at which the antenna 32 transmits to adjust for changes in environmental conditions which may affect the antennas 32.

In certain embodiments, the present invention may consider a number of identification signals received from tag 70 in response to receipt by tag 70 of a number of wake-up signals from a number of activation antennas 202. A receiver 204 or other component of the system may use this information to determine the location, directionality, and velocity of tag 70. Using information in identification signals for a number of antennas 202 may provide a more accurate or more useful measure of the movement of tag 70 throughout an environment.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A tag tracking system, comprising:
a first activation antenna and a second activation antenna;
one or more antenna control modules operable to generate a first wake-up signal to be transmitted by the first antenna and a second wake-up signal to be transmitted by the second antenna, the first wake-up signal comprising an antenna ID of the first antenna and the second wake-up signal comprising an antenna ID of the second antenna; and
one or more processing modules operable to:
receive at least a first identification signal and a second identification signal from a tag, the first identification signal received from the tag in response to the receipt by the tag of the first wake-up signal and comprising a tag ID of the tag and the antenna ID included in the first wake-up signal, the second identification signal received from the tag in response to the receipt by the tag of the second wake-up signal and comprising the tag ID of the tag and the antenna ID included in the second wake-up signal;
access timing information for the first identification signal and the second identification signal;
access location information associated with the first and second antennas; and
determine a velocity of the tag based at least on the timing information for the first identification signal and the second identification signal and the location information associated with the first and second antennas.

2. The tag tracking system of claim 1, wherein the one or more processing modules are operable to receive the timing information from the tag.

3. The tag tracking system of claim 1, wherein the timing information indicates a time difference between communication of the first identification signal and communication of the second identification signal.

4. The tag tracking system of claim 3, wherein the time difference was computed by the tag according to an internal digital counter of the tag.

5. The tag tracking system of claim 3, wherein the time difference was computed by the tag using an on-board real-time clock (RTC) unit of the tag that directly logs time differences between communication of the first identification signal and communication of the second identification signal.

6. The tag tracking system of claim 3, wherein:
the first wake-up signal transmitted by the first antenna comprises a first time stamp and the second wake-up signal transmitted by the second antenna comprises a second time stamp; and
the time difference was computed by the tag by decoding the first and second time stamps.

7. The tag tracking system of claim 1, wherein:
the timing information comprises a first time stamp associated with the first identification signal and a second time stamp associated with the second identification signal; and
the one or more processing modules are operable to compute a time difference, the time difference being used to compute the velocity of the tag.

8. The tag tracking system of claim 1, wherein the one or more processing modules are operable to access the location information for the first and second antennas based on the antenna IDs of the first and second identification signals received from the tag.

9. The tag tracking system of claim 1, wherein the location information comprises a distance between the first and second antennas.

10. The tag tracking system of claim 1, wherein the one or more processing modules are further operable to determine the directionality of the tag based on the sequence in which the first and second identification signals are received from the tag.

11. The tag tracking system of claim 1, wherein the one or more processing modules comprise one or more of the following:
a receiver; and
a server system.

12. The tag tracking system of claim 1, wherein the one or more processing modules are further operable to:
receive sensor data from the tag, the sensor data comprising data determined by one or more sensors of the tag;
use the sensor data when determining one or more of the directionality of the tag, a location of the tag, and a velocity of the tag.

13. The tag tracking system of claim 12, where the one or more sensors comprise one or more of the following:
one or more accelerometers;
one or more gyroscopes;
one or more electronic compasses;
one or more acoustic sensors;
one or more infrared sensors;
one or more chemical sensors; and
one or more radiation sensors.

14. A method for tracking tags, comprising:
generating a first wake-up signal to be transmitted by a first antenna and a second wake-up signal to be transmitted by a second antenna, the first wake-up signal comprising an antenna ID of the first antenna and the second wake-up signal comprising an antenna ID of the second antenna;
receiving at least a first identification signal from a tag, the first identification signal received from the tag in response to the receipt by the tag of the first wake-up signal and comprising a tag ID of the tag and the antenna ID included in the first wake-up signal;
receiving at least a second identification signal from the tag, the second identification signal received from the tag in response to the receipt by the tag of the second wake-up signal and comprising the tag ID of the tag and the antenna ID included in the second wake-up signal;
accessing timing information for the first identification signal and the second identification signal;
accessing location information associated with the first and second antennas; and
determining a velocity of the tag based at least on the timing information for the first identification signal and the second identification signal and the location information associated with the first and second antennas.

15. The method of claim 14, comprising receiving the timing information from the tag.

16. The method of claim 14, wherein the timing information indicates a time difference between communication of the first identification signal and communication of the second identification signal.

17. The method of claim 16, wherein the time difference was computed by the tag according to an internal digital counter of the tag.

18. The method of claim 16, wherein the time difference was computed by the tag using an on-board real-time clock (RTC) unit of the tag that directly logs time differences between communication of the first identification signal and communication of the second identification signal.

19. The method of claim 16, wherein:
the first wake-up signal transmitted by the first antenna comprises a first time stamp and the second wake-up signal transmitted by the second antenna comprises a second time stamp; and
the time difference was computed by the tag by decoding the first and second time stamps.

20. The method of claim 14, wherein:
the timing information comprises a first time stamp associated with the first identification signal and a second time stamp associated with the second identification signal; and
the method comprises computing a time difference, the time difference being used to compute the velocity of the tag.

21. The method of claim 14, comprising accessing the location information for the first and second antennas based on the antenna IDs of the first and second identification signals received from the tag.

22. The method of claim 14, wherein the location information comprises a distance between the first and second antennas.

23. The method of claim 14, further comprising determining the directionality of the tag based on the sequence in which the first and second identification signals are received from the tag.

24. The method of claim 14, further comprising:
receiving sensor data from the tag, the sensor data comprising data determined by one or more sensors of the tag;
using the sensor data when determining one or more of the directionality of the tag, a location of the tag, and a velocity of the tag.

25. The method of claim 24, where the one or more sensors comprise one or more of the following:
one or more accelerometers;
one or more gyroscopes;
one or more electronic compasses;
one or more acoustic sensors;
one or more infrared sensors;
one or more chemical sensors; and
one or more radiation sensors.

26. A tag tracking system, comprising:
a plurality of activation antennas located throughout an environment, each activation antenna operable to transmit a wake-up signal, the wake-up signal transmitted by an activation antenna comprising an antenna ID of the antenna that transmitted the wake-up signal; and
one or more processing modules operable to:
receive a plurality of identification signals from a tag, each identification signal generated in response to receipt by the tag of a wake-up signal from a corresponding antenna and comprising a tag ID of the tag and the antenna ID included in the wake-up signal of the antenna that transmitted the wake-up signal; and
determine a directionality of the tag based on the sequence in which the plurality of identification signals are received from the tag.

27. The tag tracking system of claim 26, wherein the one or more processing modules are further operable to:
access timing information for the plurality of identification signals according to the plurality of identification signals received from the tag;
access location information associated with the plurality of antennas according to the plurality of identification signals received from the tag; and
determine a velocity of the tag according to the timing information and location information.

28. The tag tracking system of claim 27, wherein the tag is operable to store log information associated with the wake-up signals, the log information for each wake-up signal comprising the antenna ID of the antenna that transmitted the wake-up signal and timing information associated with the wake-up signal.

29. The tag tracking system of claim 28, wherein:
the tag is operable to transmit at least a portion of the log information to the one or more processing modules; and
the one or more processing modules are operable to determine a velocity of the tag based at least in part on the log information.

30. The tag tracking system of claim 26, comprising one or more antenna control modules operable to generate the wake-up signals to be transmitted by the plurality of antennas.

31. The tag tracking system of claim 26, wherein the one or more processing modules comprise one or more of the following:
a receiver; and
a server system.

32. The tag tracking system of claim 26, wherein the one or more processing modules are further operable to:
receive sensor data from the tag, the sensor data comprising data determined by one or more sensors of the tag;
use the sensor data when determining one or more of the directionality of the tag, a location of the tag, and a velocity of the tag.

33. The tag tracking system of claim 32, where the one or more sensors comprise one or more of the following:
one or more accelerometers;
one or more gyroscopes;
one or more electronic compasses;
one or more acoustic sensors;
one or more infrared sensors;
one or more chemical sensors; and
one or more radiation sensors.

34. A method for tracking tags, comprising:
transmitting wake-up signals from a plurality of activation antennas located throughout an environment, each wake-up signal comprising an antenna ID of the antenna that transmitted the wake-up signal; and
receiving a plurality of identification signals from a tag, each identification signal generated in response to receipt by the tag of a wake-up signal from a corresponding antenna and comprising a tag ID of the tag and the antenna ID included in the wake-up signal of the antenna that transmitted the wake-up signal; and
determining a directionality of the tag based on the sequence in which the plurality of identification signals are received from the tag.

35. The method of claim 34, further comprising:
accessing timing information for the plurality of identification signals according to the plurality of identification signals received from the tag;
accessing location information associated with the plurality of antennas according to the plurality of identification signals received from the tag; and
determining a velocity of the tag according to the timing information and location information.

36. The method of claim 34, wherein the tag is operable to store log information associated with the wake-up signals, the log information for each wake-up signal comprising the antenna ID of the antenna that transmitted the wake-up signal and timing information associated with the wake-up signal.

37. The method of claim 36, wherein:
the tag is operable to transmit at least a portion of the log information to the one or more processing modules; and
the one or more processing modules are operable to determine a velocity of the tag based at least in part on the log information.

38. The method of claim 37, wherein the wake-up signals to be transmitted by the plurality of antennas are generated by one or more antenna control modules.

39. The method of claim 34, further comprising:
receiving sensor data from the tag, the sensor data comprising data determined by one or more sensors of the tag;
using the sensor data when determining one or more of the directionality of the tag, a location of the tag, and a velocity of the tag.

40. The method of claim 39, where the one or more sensors comprise one or more of the following:
one or more accelerometers;
one or more gyroscopes;
one or more electronic compasses;
one or more acoustic sensors;
one or more infrared sensors;
one or more chemical sensors; and
one or more radiation sensors.
